(19) United States
(12) Patent Application Publication
(10) Pub. No.: US 2018/0153366 A1
(43) Pub. Date: Jun. 7, 2018

(54) Liquid Filtration Vacuum

(71) Applicant: Intelliclean Solutions, LLC, St. Peterburg, FL (US)

(72) Inventors: Larry York, St. Petersburg, FL (US); Randy Spencer, St. Petersburg, FL (US)

(21) Appl. No.: 15/888,361

(22) Filed: Feb. 5, 2018

Related U.S. Application Data
(63) Continuation-in-part of application No. 15/133,146, filed on Apr. 19, 2016, now Pat. No. 9,883,782.
Application No. 15/133,146 is a continuation-in-part of application No. 14/885,975, filed on Oct. 16, 2015, now Pat. No. 9,782,049.
(60) Provisional application No. 62/122,300, filed on Oct. 16, 2014.

(51) Int. Cl. A47L 9/18; B01D 47/02; A47L 9/04; A47L 9/26; A47L 9/32

(52) U.S. Cl. CPC A47L 9/181; B01D 47/02; A47L 9/322; A47L 9/26; A47L 9/0411

(57) ABSTRACT

The liquid filtration vacuum cleaner includes a vacuum nozzle head and a housing moveably coupled to the vacuum nozzle head. The vacuum cleaner further includes a liquid tank that includes a wall defining an interior volume and a tank intake channel positioned in the interior volume. The interior volume is configured to hold a liquid. The tank intake channel is positioned to direct debris received from an intake passageway into the liquid tank so that the liquid in the interior volume of the liquid tank filters the debris into the liquid so that clean air is exhausted. The vacuum cleaner further includes a separator configured to generate an airflow.

### CROSS-REFERENCE TO RELATED APPLICATION

This application is a continuation-in-part of pending U.S. patent application Ser. No. 15/133,146, filed Apr. 19, 2016, which in turn is a continuation-in-part of issued U.S. Pat. No. 9,782,049, issued Oct. 10, 2017, which in turn claimed the benefit of U.S. Provisional Application No. 62,122,300, filed Oct. 16, 2014.

### FIELD

The present disclosure pertains to the field of vacuum cleaners and more particularly to a liquid filtration vacuum.

### BACKGROUND

There are available today various types of vacuum cleaners. One type of vacuum cleaner is a canister type. Canister type vacuum cleaners typically have a relatively stationary canister which is connected to a movable wand by a flexible connecting hose. Another type of vacuum cleaner is an upright-style vacuum cleaner. Upright-style vacuum cleaners are typically integrated units having an inlet, a filter, bag, and/or canister, and a handle connected together vertically in a single, portable unit. Upright-style vacuum cleaners may provide greater versatility and convenience than canister type vacuum cleaners because the upright-style vacuum cleaner is an integrated unit that can be moved and maneuvered by a single handle.

Traditional vacuum cleaners typically utilize mechanical filters to filter dirt and debris from directed airflow before returning the filtered air into the atmosphere. Some vacuum cleaners use bags to collect the dirt and debris, while some utilize a bin collection system. Vacuum cleaners that use bags, bins, and/or other mechanical filters lose efficiency with each use because dirt and dust captured by these components can clog the ports that allow air to flow through them. As a result, mechanical filters have to be replaced regularly, and still send germs, bacteria and dust back into the atmosphere when in use. Those who suffer breathing disorders such as asthma or have allergies are especially vulnerable. Purchasing mechanical filters and vacuum bags can make any vacuum cleaner very expensive to use and operate over time.

Vacuum bags create germs and bacteria, as well as smell and lose efficiency. As such, traditional vacuum cleaners may be deficient.

### SUMMARY

According to one embodiment, an upright liquid filtration vacuum cleaner includes a vacuum nozzle head and a housing moveably coupled to the vacuum nozzle head. The movable coupling is configured to allow the housing to tilt backwards with respect to the vacuum nozzle head. The vacuum cleaner further includes a liquid tank that is removably insertable into the housing. The liquid tank includes a wall defining an interior volume and a tank intake channel positioned in the interior volume. The interior volume is configured to hold a liquid. The tank intake channel is in fluid communication with an intake passageway that extends from the tank intake channel to an opening in the vacuum nozzle head. The tank intake channel is further positioned to direct debris received from the intake passageway into the liquid tank such that the liquid in the liquid tank can filter the debris into the liquid so that clean air is exhausted. The vacuum cleaner further includes a motor coupled to the housing and a separator coupled to the housing and the motor. The separator is in fluid communication with the interior volume of the liquid tank. The separator is configured to generate an airflow and further configured to prevent the liquid from being exhausted out of the interior volume of the liquid tank through the separator. The vacuum cleaner is configured to seal the intake passageway when the vacuum cleaner is deactivated so as to prevent the liquid from leaking out of the interior volume of the liquid tank through the intake passageway. The vacuum cleaner is further configured to unseal the intake passageway when the vacuum cleaner is activated so as to allow the debris to be received in the interior volume of the liquid tank from the intake passageway. The vacuum cleaner is configured to operate as a wet vacuum in which the debris comprises a liquid to be extracted. The vacuum cleaner is further configured to operate as a dry vacuum in which the debris comprises a non-liquid matter.

In some embodiments, the vacuum cleaner is devoid of a dry, mechanical filter. In some embodiments, the vacuum cleaner includes a dry, mechanical filter.

In some embodiments, the tank intake channel is further positioned to direct the debris received from the intake passageway to below a liquid level of the liquid.

In some embodiments, the tank intake channel is further positioned to direct the debris received from the intake passageway to above a liquid level of the liquid.

In another embodiment, an upright liquid filtration vacuum cleaner includes a vacuum nozzle head and a housing moveably coupled to the vacuum nozzle head. The movable coupling is configured to allow the housing to tilt backwards with respect to the vacuum nozzle head. The vacuum cleaner further includes a liquid tank that is removably insertable into the housing. The liquid tank includes a wall defining an interior volume and a tank intake channel positioned in the interior volume. The interior volume is configured to hold a liquid. The tank intake channel is in fluid communication with an intake passageway that extends from the tank intake channel to an opening in the vacuum nozzle head. The tank intake channel is further positioned to direct debris received from the intake passageway to below a liquid level of the liquid. The vacuum cleaner further includes a sealing flap positioned at a location in the intake passageway. The sealing flap has a first position configured to seal the intake passageway so as to prevent the liquid from leaking out of the interior volume of the liquid tank through the intake passageway. The sealing flap also has a second position configured to open the seal of the intake passageway so as to allow the debris to be received in the interior volume of the liquid tank from the intake passageway such that the liquid in the liquid tank can filter the debris into the liquid so that clean air is exhausted. The vacuum cleaner further includes a motor coupled to the housing, and a separator coupled to the housing and the motor. The separator is in fluid communication with the interior volume of the liquid tank. The separator is configured to generate an airflow and is further configured to prevent the liquid from being exhausted out of the interior volume of the liquid tank through the separator. The vacuum cleaner is configured to move the sealing flap from the first position to the second position when the vacuum cleaner is activated. The vacuum cleaner is further configured to move the sealing flap from the second position to the first position when the vacuum cleaner is deactivated. The vacuum cleaner is configured to operate as a wet vacuum in which the debris comprises a liquid to be extracted, and further configured to operate as a dry vacuum in which the debris comprises a non-liquid matter.

In some embodiments, the wall of the water tank includes antimicrobial particles. In some embodiments, the antimicrobial particles comprise micro silver particles. In some embodiments, the antimicrobial particles comprise nano silver particles.

In some embodiments, the liquid tank further includes a second tank intake channel positioned in the interior volume. The second tank intake channel is in fluid communication with a second intake passageway that extends from the second tank intake channel to the opening in the vacuum nozzle head. The second tank intake channel is further positioned to direct debris received from the second intake passageway to below the liquid level of the liquid. The vacuum cleaner further includes a second sealing flap positioned at a location in the second intake passageway. The second sealing flap has a first position configured to seal the second intake passageway so as to prevent the liquid from leaking out of the interior volume of the liquid tank through the second intake passageway. The second sealing flap also has a second position configured to open the seal of the second intake passageway so as to allow the debris to be received in the interior volume of the liquid tank from the second intake passageway. The vacuum cleaner is further configured to move the second sealing flap from the first position to the second position when the vacuum cleaner is activated, and further configured to move the second sealing flap from the second position to the first position when the vacuum cleaner is deactivated.

In some embodiments, both the intake passageway and the second intake passageway are positioned in the housing in locations behind the water tank.

In some embodiments, the intake passageway and the second intake passageway are positioned in the housing in locations opposite from each other.

In some embodiments, the vacuum cleaner further includes an automated flap mover configured to move the sealing flap from the first position configured to seal the first intake passageway so as to prevent the liquid from leaking out of the interior volume of the liquid tank through the intake passageway to the second position configured to open the seal of the intake passageway so as to allow the debris to be received in the interior volume of the liquid tank from the intake passageway. In some embodiments, the automated flap mover is a solenoid. In some embodiments, the vacuum cleaner further includes one or more movement resistors coupled to the sealing flap and configured to resist the movement of the sealing flap from the first position to the second position. The strength of the one or more movement resistors is configured to be overcome by the automated flap mover, the airflow, or both the automated flap mover and the airflow.

In some embodiments, the vacuum cleaner further includes one or more movement resistors coupled to the sealing flap and configured to resist the movement of the sealing flap from the first position to the second position. The strength of the one or more movement resistors is configured to be overcome by the airflow.

in some embodiments, the movable coupling is further configured to allow the housing to tilt backwards with respect to the vacuum nozzle head from a substantially upright position to a substantially horizontal position.

In another embodiment, a water filtration vacuum includes a micro silver (or nano silver) permeate for anti-bacterial and anti-fungal properties. The water filtration vacuum device draws in the air, forcing it into the water and mixing it with microbial nanoparticles (e.g., micro silver), returning clean, fresh water-washed, substantially purified air into the home environment. [0021] In another embodiment, a water filtration vacuum cleaner comprises an upright-style vacuum cleaner having, among other things, a water tank and intake tubes for directing drawn air from the vacuum cleaner inlet to tank intake channels in the water tank. The tank intake channels extend below the water level such that intake air is exhausted from the tank intake channels directly into the water.

In some embodiments, the water tank includes reversible seals for sealing against the intake tubes while the vacuum cleaner is not operating, to prevent water from leaking out through the intake tubes. The reversible seals open when the vacuum cleaner is operating and there is airflow through the intake tubes.

In some embodiments, micro silver or nano silver particles are molded into the inner wall of the water tank for contacting the air in the water tank.

In another embodiment, an upright water filtration vacuum contains an antimicrobial particulate for anti-bacterial and anti-fungal properties. The water filtration vacuum device draws in the air, forcing it into the water and mixing it with, e.g., micro silver or nano silver particles, returning clean, fresh air into the home environment.

In another embodiment, a water-filter vacuum cleaner is provided having micro silver or nano silver impregnated qualities.

In another embodiment, a water-filter vacuum cleaner is provided m which thexhausted air is free of bacteria.

In another embodiment, a water-filter vacuum cleaner is provided where all the dirt is sucked into the water and captured and mixed with the micro silver or nano silver particles for antibacterial and antifungal properties.

In another embodiment, an upright-style vacuum cleaner is provided having a liquid-tight liquid filter incorporated into the vertical assembly.

### BRIEF DESCRIPTION OF THE DRAWINGS

The invention can be best understood by those having ordinary skill in the art by reference to the following detailed description when considered in conjunction with the accompanying drawings in which:

FIG. 1 is a front view of an example vacuum cleaner;

FIG. 2 is a perspective view of the vacuum cleaner of FIG. 1;

FIG. 3 is a rear elevation view of the vacuum cleaner of FIG. 1;

FIG. 4 is a side view of the vacuum cleaner of FIG. 1;

FIG. 5 is an additional front view of the vacuum cleaner of FIG. 1;

FIG. 6 is a detailed side view of an exemplary water tank intake of the vacuum cleaner of FIG. 1;

FIG. 7 is a side view of an example sealing flap and movement resistor positioned within the vacuum cleaner of FIG. 1;

FIG. 8 is a front view of an example sealing flap and movement resistor for a vacuum

FIG. 9 is a is a side view of the sealing flap and movement resistor of FIG. 8;

FIG. 10 is a view of an example water tank detached from the housing of the vacuum cleaner of FIG. 1;

FIG. 11 is a view of an example motor of the vacuum cleaner of FIG. 1;

FIG. 12 is a detailed view of the motor of FIG. 11;

FIG. 13 shows the separator;

FIG. 14 shows the retractable extension cord; and

FIG. 15 shows a side view of a vacuum cleaner that can operate as a wet vacuum.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

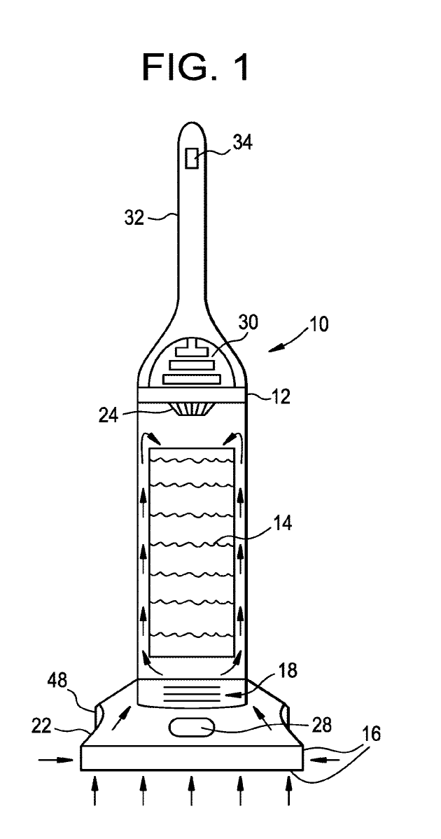

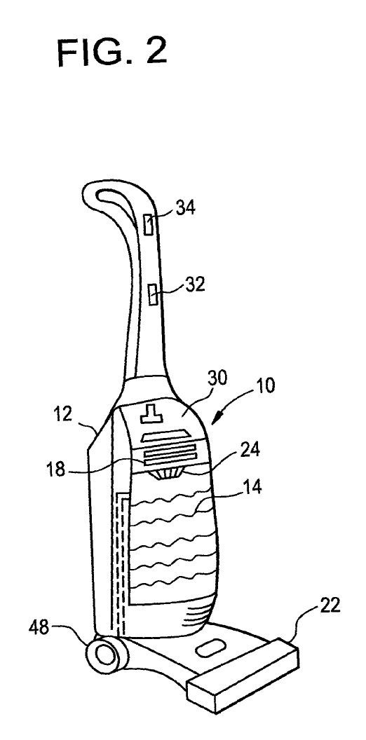

Examples of the present disclosure are best understood by referring to FIGS. 1-15 of the drawings, like numerals being used for like and corresponding parts of the various drawings

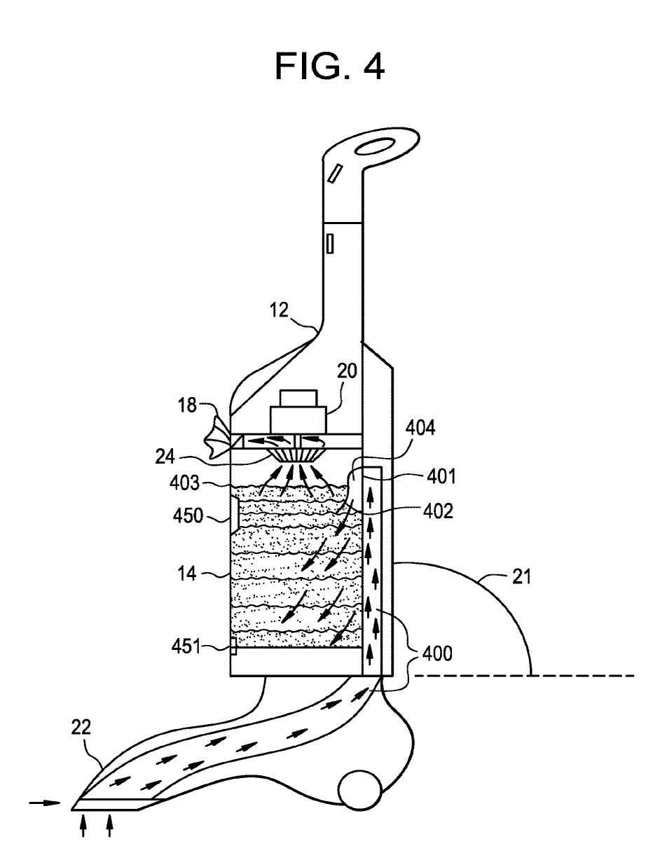

Referring now to the figures and particularly to FIG. 1, there is shown an exemplary upright vacuum cleaner 10 having housing 12. Removably contained within housing 12 is water tank or filtration liquid tank 14. In an exemplary embodiment, the water tank 14 is easily removable from housing 12 to enable the convenient removal and replacement of liquid therein. The water tank 14 may have any shape and/or size. Motor 20 (FIG. 4) is positioned within (or otherwise supported by) the housing 12.

The water tank 14 may include liquid (such as water) that contacts the air flow into the vacuum cleaner 10 and removes debris. The vacuum cleaner 10 directs incoming air and debris into contact with the liquid, which is typically water that absorbs the debris. Air flow through the water tank 14 also causes the liquid to circulate or agitate, which increases the efficiency of the absorption. The use of liquid as a filter (as opposed to a dry, mechanical filter) has a significant advantage in that the vacuum cleaner 10 uses readily available water, thereby eliminating the need for replaceable filters. In addition, the liquid in the water tank 10 may provide a room humidifying effect since some of the water may become vaporized in the air discharged from the vacuum cleaner 10 during use.

Air is discharged out exhaust port 18.

Further shown is vacuum cleaner handle 32 that may telescope up and down, and compartment 30 for storing attachments typically used with vacuum cleaners. Vacuum nozzle head 22 contains a brushing unit (not shown in FIG. 1) typically contained in vacuum cleaners for brushing carpet free of debris, and may further include a rubber squeegee. Suction and airflow motor 28 is supported in vacuum nozzle head in standard fashion. Suction and airflow motor 28 may rotate the brushing unit, causing the vacuum nozzle head 22 to be a power nozzle. Wheels 48 are located on the four corners of vacuum nozzle head 22 providing smooth rolling support of vacuum cleaner 10. In other embodiments, other wheel and support arrangements may be used.

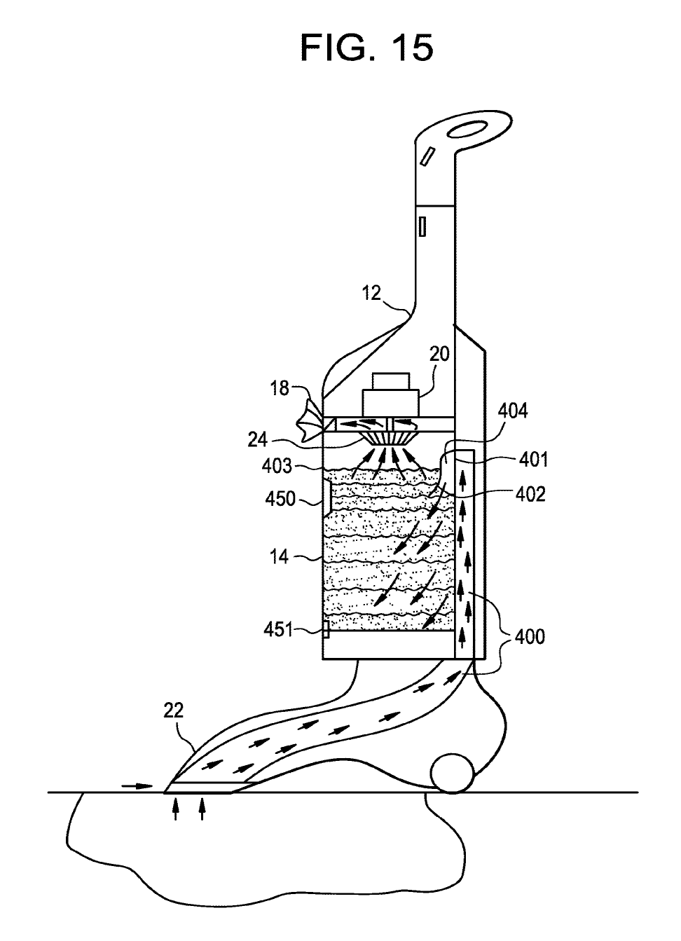

In operation, switch 34 initializes motor 20 of vacuum cleaner 10 creating an airflow and suction force, or vacuum, to draw air (shown by arrows) entrained with debris. The debris can be any non-liquid matter, such as dust, dirt, particulates, microbes, and/or contaminants, or as is seen in FIG. 15, liquid matter. The air entrained with debris is drawn in through the vacuum nozzle head 22 and the inlet ports 16 and into contact with the liquid filter water tank 14. Motor 20 contained within housing 12 operates separator 24, rotating the separator 24 to speeds up to 16,000 rpm, forcing the debris to mix with water in water tank 14. By mixing the debris with the water, the debris is absorbed into the water and is prevented from being exhausted from the water tank 14. Additionally, separator 24 may draw and separate the clean exhaust air from the heavier water and particulates. The liquid filter water tank 14 may utilize one or more known liquid agents with filtration qualities, but contains water in an exemplary embodiment.

The housing 12 may be moveably coupled to the vacuum nozzle head 22. For example, the housing 12 may be tilted (or otherwise moved) with respect to the vacuum nozzle head 22. As is illustrated in FIG. 4, the housing 12 may be titled backwards from an upright position with respect to the vacuum nozzle head 22 by a tilting angle 21. Tilting angle 21 may be any angle. The housing 12 may be tilted with respect to the vacuum nozzle head 22. Thus, even when the housing 12 is tilted, the vacuum nozzle head 22 may remain in the same upright position (shown in FIG. 4).

Tilting of the housing 12 may be accomplished by pressing a button or lever positioned on the housing 12 or the vacuum nozzle head 22, or the housing 12 may tilt freely with respect to the vacuum nozzle head 22. This button or lever may release the housing 12, allowing housing 12 to be tilted. When the housing 12 is tilted, all of the components of the housing 12 (including the water tank 14) may be titled at the same (or substantially the same) angle as the housing 12.

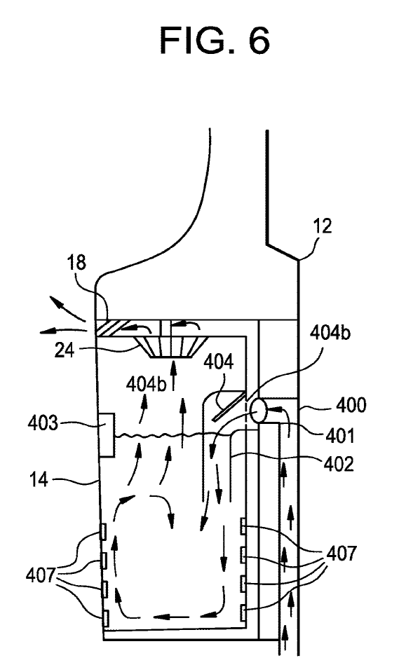

Water tank 14 can be a liquid reservoir or basin made of plastic or other materials and molded using known techniques. Liquid or dry micro silver, or nano silver, may be used as an antimicrobial component in the exemplary embodiment, although any suitable microbial agent may be used. The micro or nano silver can be included into the plastic mold during processing. Any amount of micro or nano silver may be poured into the plastic mold. For example, the micro silver (or any other antimicrobial particle) may make up 1%-6% of the plastic mold. In some examples, the micro silver may make up 5% of the plastic mold. In some examples, this percentage of micro silver may allow the water tank 14 to achieve approximately 100% efficiency for killing contaminants in the water tank 14. Antimicrobial particles 407, such as nano-silver, are shown in FIG. 6, in the wall of the water tank 14 during operation of the vacuum cleaner 10. As shown in FIG. 6, antimicrobial particles 407 are embedded into the water tank interior wall and the circulation of water (shown by arrows), including contaminants, bring the contaminants into contact with the antimicrobial particles 407 to kill them.

Antimicrobial particles may be nano particles, e.g., nano metal ions, oxides, and salts placed in the liquid bath, air flow stream, and/or embedded in the airflow pathway/componentry. Antimicrobial particles may also be micro particles, e.g., micro metal ions, oxides, and salts. Micro particles may be particles with a size within 0.1-100 μm, 0.3-300 μm, 0.7-700 μm, or any combination of the preceding. In particular examples, the micro particles may have a size of 200 μm (or approximately 200 μm, such as 200 μm+/−100 μm).

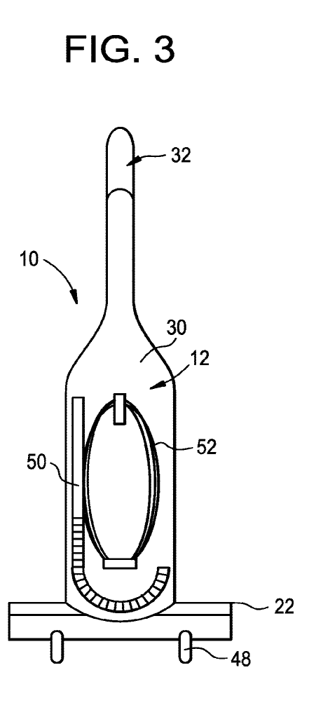

The exemplary embodiment shown in FIG. 3 includes a hose 50 for cleaning with attachments in areas where the power nozzle head 22 cannot accommodate. For suction and airflow, the hose 50 may connect with, for example, intake 400 (discussed below). Further shown is power cord 52 utilized to provide power to the vacuum cleaner 10 wrapped in typical fashion around stays.

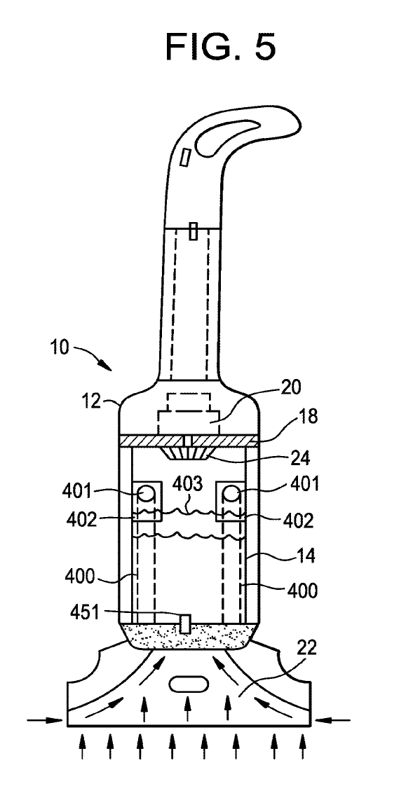

FIGS. 4 and 5 are respectively a side view and a front view of an exemplary embodiment of the water filtration vacuum cleaner 10. As shown in FIG. 4, water tank 14 is inserted into housing 12 between vacuum nozzle head 22 and motor 20. Handle 450 assists a user with inserting water tank 14 into, and removing it from housing 12. When water tank 14 is inserted into housing 12, latch 451 secures water tank 14 therein.

Motor 20 is located in the housing 12 above the water tank 14, and a separator 24 is attached to the bottom of motor 20. Separator 24 may be any device that, when operating, may generate an airflow, and that may further prevent liquid in the water tank 14 from being exhausted out of the water tank 14 through the separator 24. In some examples, separator 24 may separate air from the liquid. For example, separator 24 may draw and separate the clean exhaust air from the heavier water and particulates. This may allow the separator to prevent liquid in the water tank 14 from being exhausted out of the water tank 14 through the separator 24. Separator 24 may also force dirt and debris to mix with liquid in water tank 14.

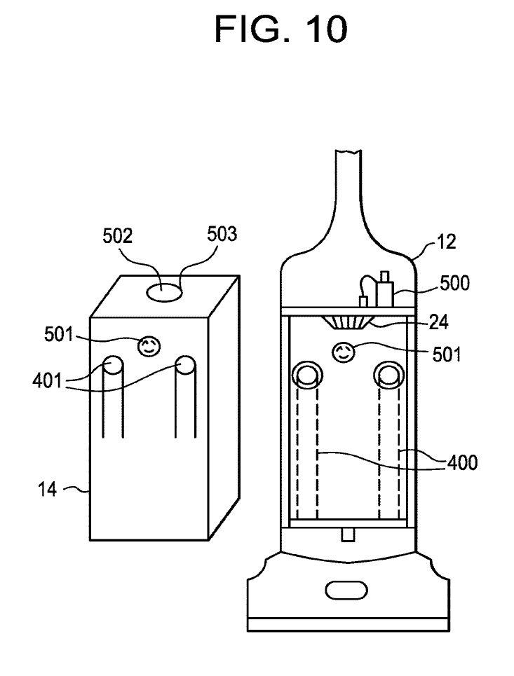

When the water tank 14 is in place within the housing 12, separator 24 protrudes through an opening 502 (FIG. 10) on the top of water tank 14. During operation of the vacuum cleaner 10, separator 24 is rotated by the motor at high speeds, for example and without limitation, approximately 16,000 rpm, to create airflow through the vacuum cleaner 10. The motor 20 and separator 24 generates an airflow speed (or intake velocity) of 90-130 miles per hour in each of the intakes 400 of the vacuum cleaner 10. Air is drawn from outside the housing 12 up intake 400 on either side of the housing 12, through the water tank 14, into the separator 24, and out exhaust ports 18. Exhaust ports 18 may have any size and/or shape. Furthermore, exhaust ports 18 may be positioned at any location on the housing 12 so as to allow air to be exhausted from vacuum cleaner 10. For example, exhaust ports 18 may be positioned on a front side of the housing 12, on one or more sides of the housing 12, on the back of the housing 12, or any combination of the preceding. In some examples, exhaust ports 18 may surround all or a portion of the housing 12.

Intake 400 forms an airflow path from the vacuum nozzle head 22 to inlet port 401 on water tank 14. Inlet port 401 forms an airflow path to the interior of water tank 14. Inlet 401 and intake 400 may collectively form an intake passageway that extends from the tank intake channel 402 to an opening in the vacuum nozzle head 22, such as the opening created by inlet ports 16 in the vacuum nozzle head 22.

Inlet port 401 is above the water level 403 inside water tank 14 to prevent water from entering inlet port 401 and intake tube 400 during operation. Air exhausted from intake 400 passes through inlet port 401 and into tank intake channel 402, which directs the air into the water beneath the water level 403. The tank intake channel 402 may extend under the water level 403 by any distance. This may increase the saturation of the air directed into the water.

In the front view of FIG. 5, intakes 400 are drawn in dashed lines to indicate that they are positioned behind water tank 14. Similarly, tank intake channel 402 is shown transparent to depict inlet port 401. Vacuum cleaner 10 may include any number of intakes 400 (and inlet ports 401 and tank intake channels 402. Additionally, the intakes 400 and inlet ports 401 may be positioned in any location with regard to the water tank 14.

The flow path of the air is further detailed in FIG. 6, with a detailed view of air traveling up intake 400, into inlet port 401, past sealing flap 404 (described below), and down through tank intake channel 402 into water below water level 403 where debris can be immediately trapped and absorbed by the water. FIG. 6 shows a random flow path of air through the swirling water. In operation, forcing the airflow that contains debris below the surface of water level 403 can ensure that the debris will mix with the water and become trapped or absorbed in the water, which filters the debris from the airflow, before the airflow is exhausted from the vacuum.

Another benefit of the current exemplary embodiment of the vacuum cleaner 10 is that it will resist (or prevent) spills and leaks. For example, the vacuum cleaner 10 optionally seals the intakes 400, inlet ports 401, and/or tank intake channels 402 when the vacuum cleaner is deactivated (such as when the separator 24 is not generating airflow). This prevents liquid in the water tank 14 from leaking out of the water tank 14 through the intakes 400, inlet ports 401, and/or tank intake channels 402. Additionally, the vacuum cleaner 10 unseals the intakes 400, inlet ports 401, and/or tank intake channels 402 when the vacuum cleaner is activated (such as when the separator 24 is generating airflow).

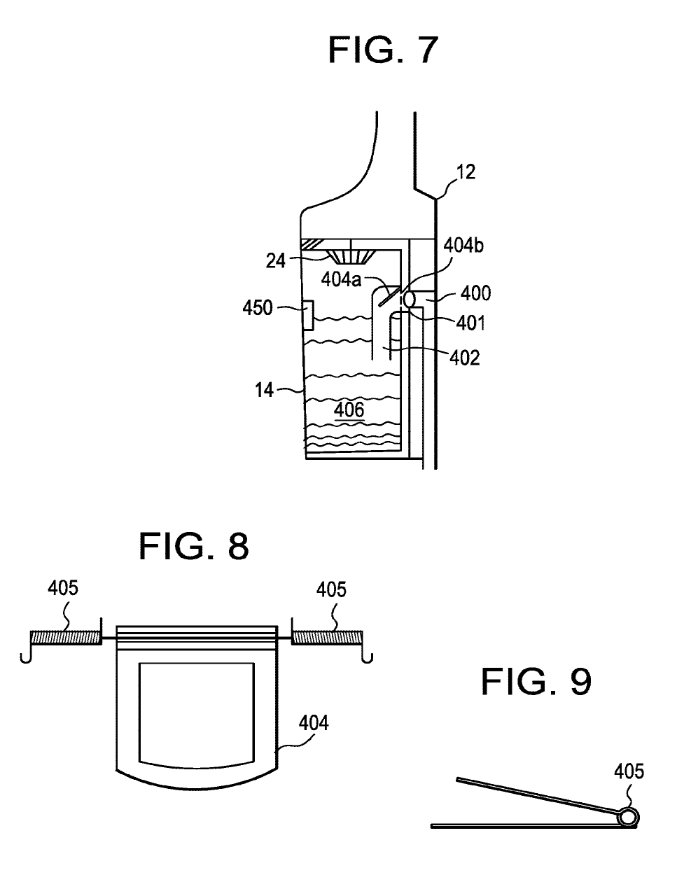

In one example, vacuum cleaner 10 may seal and unseal the intakes 400, inlet ports 401, and/or tank intake channels 402 using sealing flaps 404 shown in FIGS. 4-7. With reference now to FIGS. 4-7, water tank 14 includes sealing flap 404 for closing inlet port 401 within the air intake passages to prevent leaks when the vacuum cleaner 10 is not operating. When the vacuum cleaner 10 is operating (or activated), the air flow from intake 400 to tank intake channel 402 (and/or an automated flap mover 500, discussed below) forces sealing flap 404 open, allowing air to pass through and down into the liquid in water tank 14 via tank intake channel 402. FIG. 7 shows the sealing flap 404 in open 404a and closed 404b (dashed line) configurations. When the vacuum cleaner 10 is not operating (or deactivated), i.e., there is no airflow through intake 400, sealing flap 404 is forced to the closed configuration 404b by a flap movement resistor 405 (such as one or more springs) shown in FIGS. 8 and 9 (and/or the automated flap mover 500 shown in FIG. 10). When the vacuum cleaner 10 is operating and there is airflow through intake tube 400 and inlet port 401, the force of the airflow (and/or the force of the flap movement resistor 500) may overcome the strength (or force) of the flap movement resistor 405 and urges the sealing flap 404 to the open position 404a as depicted in FIGS. 4 and 6.

By closing, and remaining closed, when the vacuum cleaner 10 is not operating, the sealing flap 404 prevents liquid from leaking out of intake 400, thereby resisting spills and leaks of the liquid. The closed sealing flap 404 prevents such leaks even when the vacuum cleaner 10 is tipped or tilted.

In the exemplary embodiment shown by FIGS. 7-9, sealing flap 404 is made from rubber and is generally U-shaped with two flap movement resistors 405 (such as springs) attached to the top of the ‘U’. The flap movement resistors 405 are also attached to the wall of the water tank 14 proximate inlet port 401.

A flap movement resistor 405 may be any device and/or structure that may resist movement of the sealing flap 404 from a closed position (404b) to an open position (404a). By doing so, the flap movement resistor 405 may urge the sealing flap 404 towards the inlet port 401 (e.g., it may urge the sealing flap 405 to a closed position).

In the absence of an opposing force, the flap movement resistor(s) 405 causes the sealing flap 404 to seal against inlet port 401 and/or intake tube 400 as shown in the closed configuration 404b of FIG. 5. Thus, when the vacuum cleaner 10 is not in operation, sealing flap 404 prevents water from leaking out of the water tank 14 through the inlet port 401 and/or intake 400 even if the vacuum cleaner 10 is tipped or tilted.

FIG. 10 shows another example of a sealing flap 404 assembly. As shown in FIG. 10, an automated flap mover 500 is provided in housing 12 and is electrically connected to socket 501 on housing. When water tank 14 is inserted into housing 12, sockets 501 connect, thereby providing a pathway to provide power to the automated flap mover 500. When switch 34 is activated, thus turning on motor 20 and causing separator 24 to generate airflow, power is provided to the automated flap mover 500. This causes the automated flap mover 500 to move the sealing flap 404 from the closed position 404b to the open position 404a. Additionally, when the switch 34 is deactivated (or the vacuum cleaner 10 loses power, such as if the power plug is pulled from an electrical outlet), the automated flap mover 500 moves the sealing flap 404 from the open position 404a to the closed position 404b. The automated flap mover 500 will keep the sealing flap 404 in the closed position 404b until the switch 34 is once again activated (or the motor 20 and separator 24 are otherwise turned on). This prevents liquid from leaking out of intakes 400 even if the vacuum cleaner 10 is tipped or tilted.

Automated flap mover 500 may be any device and/or structure that moves sealing flap 404. For example, automated flap mover 500 may be a solenoid, a solenoid valve, a motorized lever, any other mechanical device for causing movement, any other electro/mechanical device for causing movement, any other device and/or structure for causing automated movement, or any combination of the preceding.

As previously indicated, FIG. 10 further depicts opening 502 on top of water tank 14. Opening 502 is used to empty and fill water tank 14, but is also configured to accept separator 24 when the water tank 14 is inserted into housing 12. Water tank opening 502 includes a raised lip 503 in an exemplary embodiment for sealing against a motor gasket 25 as will be explained with respect to FIGS. 9-11. In other embodiments, opening 502 may be sealed in any other manner suitable for creating a water-tight seal, such as frictional engagements, slotted grooves, a-rings, etc. In general, the centrifugal force generated by separator 24 while vacuum cleaner 10 is in operation is sufficient to deflect any water away from the motor 20 assembly seal.

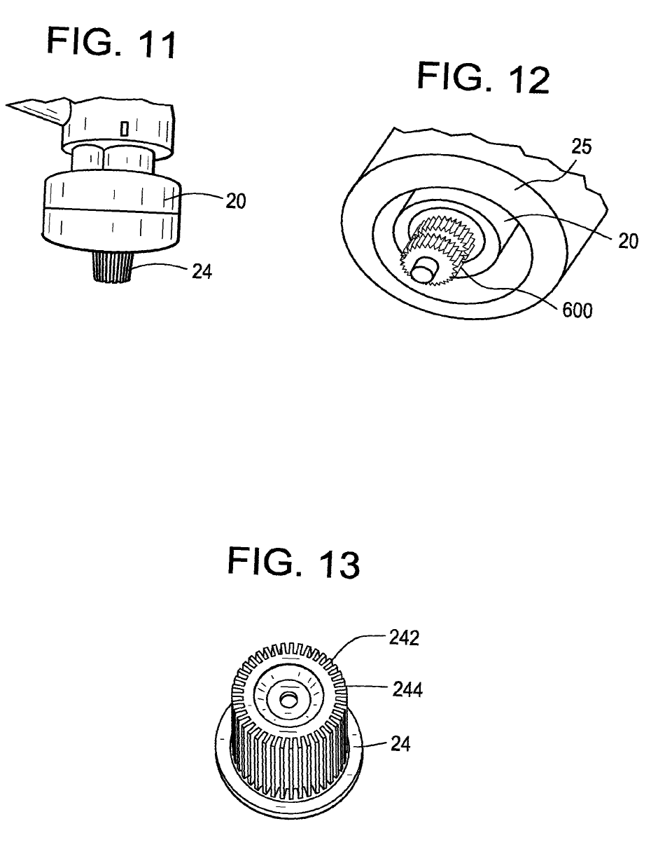

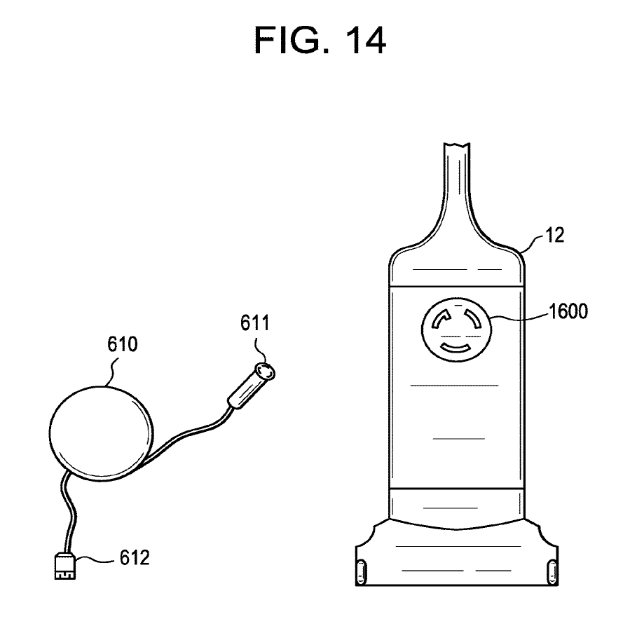

FIGS. 11-13 show additional details regarding the coupling between the motor 20 and the separator 24. As shown in FIG. 11, separator 24 extends away from a bottom of motor 20. Separator 24 is shown in FIG. 13. The ribs 242 and grooves 244 of separator 24 (FIG. 13) create the required airflow for the vacuum cleaner 10 during operation when the separator is rotating. FIG. 12 shows the bottom of motor 20 including gears 600 and gasket 25. During operation, separator 24 is connected to gears 600 such that motor 20 rotates separator 24.

Lip 503 around opening 502 (as illustrated in FIG. 10) on the top of water tank 14 is configured to engage the motor gasket 25 and seal the water tank 14 to the motor 20 when the water tank 14 is inserted in housing 12.

FIG. 14 shows an exemplary removable power connection for the vacuum cleaner 10. The back of housing 12 includes a circular connector 1600 in an exemplary embodiment that mates with a female circular connector 611 on a retractable power cord organizer 610. On an opposite end is a wall outlet 612 (such as a standard 120V wall outlet), which may be unplugged or left plugged in when a user is finished using the vacuum cleaner 10. Retractable power cord organizer 610 is removable from the housing 12, and reattached as discussed above. Any other power connection may be used with the vacuum cleaner 10.

FIG. 15 shows a side view of a vacuum cleaner that can operate as a wet vacuum. As is illustrated, the vacuum cleaner 10 is an upright-style vacuum that can operate as a wet vacuum. When the vacuum cleaner 10 is operating, the vacuum nozzle head 22 (or the hose of the vacuum cleaner 10) may be positioned over liquid (such as water) or a combination of liquid and a dry debris or dirt. The airflow and suction created by the motor 20 and separator 24 may then perform liquid extraction (or water extraction) by drawing the liquid (or liquid and dry debris or dirt) into intake 400. As is illustrated in FIG. 15, the extracted liquid may travel up intake 400, into inlet port 401, past sealing flap 404 (described above), and down through tank intake channel 402 into water tank 14, such as into water below water level 403 in water tank 14. Separator 24 may draw and separate the clean exhaust air from the extracted liquid and any dry debris or dirt. While the clear exhaust air may pass through the separator 24, the extracted liquid may remain in water tank 14. This prevents the extracted liquid from causing damage to one or more components of the vacuum cleaner 10, and thereby allow the vacuum cleaner 10 to operate as a wet vacuum.

Equivalent elements can be substituted for the ones set forth above such that they perform in substantially the same manner in substantially the same way for achieving substantially the same result.

It is believed that the system and method as described and many of its attendant advantages will be understood by the foregoing description.

It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. An upright vacuum cleaner that filters air using water, the upright vacuum cleaner comprising:
a housing having a front, back, top, and bottom;
a handle extending from the top of the housing;
a suction head extending from the bottom of the housing;
an air intake that conveys air from the suction head, upwardly through the housing, and to an inlet port;
a water tank intended to hold water to act as a filter;
the water tank removably affixed within the housing, the housing partially surrounding the water tank when the water tank is installed;
a basin intake channel carrying air from the inlet port into the water;
wherein the water tank is non-structural, and thus is readily removable without affecting the ability of the upright vacuum to remain standing.

2. The upright vacuum cleaner of claim 1, where in the inlet port of the air intake is formed from a first port and a second port;
the first port of the inlet port located within a wall of the housing, allowing air to exit the air intake.

3. The upright vacuum cleaner of claim 2, wherein the second port of the inlet port is located within a wall of the water tank, allowing air to enter the water tank.

4. The upright vacuum cleaner of claim 1, wherein the water tank is molded from a combination of plastic and nano-silver.

5. The upright vacuum cleaner of claim 1, wherein the water tank is molded from a combination of plastic and micro-silver.

6. The upright vacuum cleaner of claim 1, further comprising:
an inlet port seal mechanically connected to the inlet port;
a spring affixed to the inlet port seal, the spring acting to close the inlet port seal to prevent water leakage.

7. The upright vacuum cleaner of claim 1, further comprising:
a separator powered by a first motor, the separator affixed to the housing and protruding outward from the housing;
the separator drawing the air through the water tank, removing water entrained in the air, and pushing the resulting air to an exhaust; and
the separator passing through the upper opening of the water tank when the water tank is installed within the housing.

8. The upright vacuum cleaner of claim 1, wherein the suction head further comprises:
a second motor;
the second motor powering a rotating brush;
whereby the rotating brush acts to lift debris from an underlying surface, allowing the debris to be lifted away by the air.

9. The upright vacuum cleaner of claim 1, further comprising:
a two-part socket, the first part affixed to the housing, the second part located on the water tank;
a solenoid-actuated inlet port seal electrically connected to the socket;
whereby installation of the water tank connects the first part of the two-part socket to the second part of the two-part socket, activating the solenoid-actuated inlet port seal, and closing the inlet port.

10. The upright vacuum cleaner of claim 1, further comprising:
a male circular connector protruding from the back of the housing;
a retractable power cord contained within a cord housing;
the cord housing including a female circular connector;
whereby the male circular connector and the female circular connector mate to affix the retractable power cord to the upright vacuum cleaner.

11. An upright vacuum cleaner that filters air using only water, the upright vacuum cleaner comprising:
a housing having a front, back, top, and bottom;
a handle extending from the top of the housing;
a suction head extending from the bottom of the housing;
an air intake that conveys air from the suction head, upwardly through the housing, and to an inlet port;
the inlet port formed from a first port and a second port;
the first port of the inlet port located within a wall of the housing, allowing air to exit the air intake;
a water tank to hold water to act as a filter;
the water tank removably affixed within the housing, the housing partially surrounding the water tank when the water tank is installed;
the second port of the inlet port located within a wall of the water tank, allowing air to enter the water tank;
a basin intake channel carrying air from the second port and into the water;
the first port and the second port connected when the water tank is installed within the housing;
the water tank including an upper opening;
an inlet port seal mechanically connected to the inlet port;
a spring affixed to the inlet port seal, the spring acting to close the inlet port seal to prevent water leakage;
a separator powered by a first motor,
the separator drawing the air through the water tank, removing water entrained in the air, and pushing the resulting air to an exhaust; and
wherein the water tank is non-structural, and thus is readily removable without affecting the ability of the upright vacuum to remain standing.

12. The upright vacuum cleaner of claim 11, wherein the suction head further comprises:
a second motor;
the second motor powering a rotating brush;
whereby the rotating brush acts to lift debris from an underlying surface, allowing the debris to be lifted away by the air.

13. The upright vacuum cleaner of claim 11, further comprising:
a male circular connector protruding from the back of the housing;
a retractable power cord contained within a cord housing;
the cord housing including a female circular connector;
whereby the male circular connector and the female circular connector mate to affix the retractable power cord to the upright vacuum cleaner.

14. An upright vacuum cleaner that uses water as a filtration mechanism, the upright vacuum cleaner comprising:
a housing;
a handle affixed to a top of the housing;
a head affixed to a bottom of the housing;
a water tank partially surrounded by the housing;
wherein the water tank is non-structural, and thus is removable without affecting the ability of the upright vacuum to remain standing.

15. The upright vacuum cleaner of claim 14, further comprising:
a separator powered by a first motor;
the separator drawing the air through the water tank, removing water entrained in the air, and pushing the resulting air to an exhaust; and
the separator passing through the upper opening of the water tank when the water tank is installed within the housing.

16. The upright vacuum cleaner of claim 15, wherein the head further comprises:
a second motor;
the second motor powering a rotating brush;
whereby the rotating brush acts to lift debris from an underlying surface, allowing the debris to be lifted away by the air.

17. The upright vacuum cleaner of claim 14, further comprising:
a two-part socket, the first part affixed to the housing, the second part affixed to the water tank;
a solenoid-actuated inlet port seal electrically connected to the socket;
whereby installation of the water tank connects the first part of the two-part socket to the second part of the two-part socket, activating the solenoid-actuated inlet port seal, and closing the inlet port.

18. The upright vacuum cleaner of claim 14, further comprising:
a male circular connector protruding from the back of the housing;
a retractable power cord contained within a cord housing;
the cord housing including a female circular connector;
whereby the male circular connector and the female circular connector mate to affix the retractable power cord to the upright vacuum cleaner.
